(19) United States
(12) Patent Application Publication
(10) Pub. No.: US 2020/0139273 A1
(43) Pub. Date: May 7, 2020

(54) PARTICLE FILTERS AND SYSTEMS INCLUDING THEM

(71) Applicant: Hamid Badiei, Woodbridge (CA)

(72) Inventor: Hamid Badiei, Woodbridge (CA)

(21) Appl. No.: 16/662,498

(22) Filed: Oct. 24, 2019

Related U.S. Application Data
(60) Provisional application No. 62/750,092, filed on Oct. 24, 2018.

(51) Int. Cl. B01D 29/92; B01D 29/00; B01D 37/04; B01D 35/06; B01D 35/26

(52) U.S. Cl. CPC B01D 29/92; B01D 29/0072; B01D 35/26; B01D 35/06; B01D 37/04

(57) ABSTRACT

Certain configurations are provided of a particle filter that can be used with a vacuum pump. In some examples, the particle filter is configured to remove particles in a fluid stream prior to the fluid stream being provided to an inlet of the vacuum pump. In some instances, the particle filter may remove the particles without using any filtration media. The particle filter may be designed to permit emptying or removal of filtered particles without breaking a vacuum.

### PRIORITY APPLICATION

This application claims priority to, and the benefit of, U.S. Provisional Application No. 62/750,092 filed on Oct. 24, 2018, the entire disclosure of which is hereby incorporated herein by reference for all purposes.

### TECHNOLOGICAL FIELD

Certain configurations described herein are directed to particle filters that can be used with a vacuum device such as, for example, a vacuum pump. In some examples, the particle filter is present or part of a vacuum system designed to reduce pressure in another device or system.

### BACKGROUND

Fine particles that are present can end up in one or more of the vacuum pumps. To protect the vacuum pump, a filter including some type of solid filtration media is added. This filtration media can alter the conductance through the system as the filtration media becomes packed with the fine particles.

### SUMMARY

Certain aspects, features, examples, configurations and embodiments are described of a particulate or particle filter that is designed to remove fine particles to protect a vacuum pump. In some instances, the particle filter may be a filtration media free particle filter. In other examples, the filter desirably does not alter or change the fluidic conductance through a vacuum manifold of system over time as it filters the particles. The exact configuration, shape, size and geometry of the particle filter, the particle filter inlets and outlets and portions or regions thereof, may vary and illustrative configurations are described in more detail below.

In an aspect, a particle filter is described. In certain instances, the particle filter can be configured to remove particles from a fluid feed provided to a vacuum pump that can lower pressure in a system to less than atmospheric pressure. In some examples, the particle filter can be positioned between the system and an inlet of the vacuum pump to remove particles from the fluid in the system prior to the fluid entering into the vacuum pump inlet without using any filtration media.

In certain embodiments, the particle filter comprises a cyclonic particle separator. In other embodiments, the cyclonic particle separator comprises an inlet, an outlet and a chamber that fluidically couples the inlet to the outlet, wherein the inlet of the particle filter comprises a different cross-sectional shape than the outlet of the cyclonic particle separator. In some examples, the cyclonic particle separator comprises an inlet, an outlet and a chamber that fluidically couples the inlet to the outlet, wherein the inlet of the particle filter comprises a similar cross-sectional shape than the outlet of the cyclonic particle separator. In other examples, the particle filter comprises an electrostatic screen. In further examples, the particle filter comprises a venturi scrubber. In some examples, the particle filter is configured to be in-line between a mass analyzer and a roughing pump of a mass spectrometer. In other embodiments, a second particle filter fluidically coupled to the particle filter and positioned in series with the particle filter can be present. In some examples, a receptacle fluidically coupled to the particle filter and configured to receiver particles filtered out of the fluid can be present. In other instances, a valve can be present between the receptacle and the particle filter, wherein the valve permits emptying of the receptacle without breaking vacuum in the system.

In another aspect, a method comprises reducing pressure in a device fluidically coupled to a vacuum pump by pumping fluid from the device through a particle filter positioned between the device and the vacuum pump, wherein the particle filter is configured to remove particles in the pumped fluid prior to the fluid entering into the vacuum pump by cyclonically separating the particles in the fluid.

In certain embodiments, the device is a mass analyzer. In other embodiments, the device is a vacuum deposition chamber. In some instances, the device is a lyophilizer. In other examples, the step of cyclonically separating the particles in the fluid comprises using a cyclonic particle separator.

In an additional aspect, a method comprises reducing pressure in a device using a vacuum pump fluidically coupled to the system by pumping fluid from the device through a particle filter positioned between the device and the vacuum pump, wherein the particle filter is configured to remove particles in the pumped fluid, without using any filtration media, prior to the fluid entering into the vacuum pump by filtering out the particles in the fluid so substantially no particles exit the particle filter.

In some examples, the method comprises collecting the filtered out particles in a receptacle fluidically coupled to the particle filter. In some examples, the method comprises emptying the collected particles from the receptacle without breaking vacuum in the device. In other examples, the method comprises cyclonically separating the particles in the fluid using a cyclonic particle separator. In some examples, the method comprises separating the particles in the fluid using an electrostatic screen or a venturi scrubber.

In another aspect, a vacuum system comprising a vacuum pump and a particle filter upstream of an inlet of the vacuum pump is disclosed. In some configurations, the particle filter of the vacuum system is configured to remove particles in a fluid prior to entry of the fluid into the vacuum pump. In some examples, the particle filter is configured to remove particles without using any filtration media. In certain embodiments, the particle filter comprises a cyclonic particle separator. In other embodiments, an inlet of the cyclonic particle separator comprises a substantially similar inner diameter as an inner diameter of an outlet of the cyclonic particle separator. In further examples, the particle filter comprises an electrostatic screen. In some examples, the particle filter comprises a venturi scrubber.

In another aspect, a vacuum system comprises a vacuum pump and a particle filter upstream of an inlet of the vacuum pump, the particle filter configured to remove particles in a fluid prior to entry of the fluid into the vacuum pump, and wherein the particle filter comprises a cyclonic particle separator. In certain embodiments, the vacuum system comprises a receptacle fluidically coupled to the cyclonic particle separator, wherein the receptacle is configured to receive the removed particles. In other embodiments, the vacuum system comprises a valve fluidically coupled to the cyclonic separator and the receptacle, wherein the valve is configured to actuate between an open position and a closed position, and wherein in the closed position the receptacle can be removed without breaking the vacuum in the vacuum system. In additional embodiments, the vacuum pump is configured as a diaphragm pump or a rotary vane pump. In some examples, an outlet of the particle filter is directly coupled to an inlet of the vacuum pump without any intervening fluid lines.

In an additional aspect, a mass spectrometer comprising a vacuum pump fluidically coupled to a vacuum manifold and configured to pump fluid from the vacuum manifold to reduce pressure within the vacuum manifold is described. In some configurations, the mass spectrometer comprises a particle filter configured to remove particles in the fluid prior to entry of the fluid into the vacuum pump, wherein the particle filter is configured to remove particles without using any filtration media, and wherein the particle filter is fluidically coupled to the vacuum manifold through an inlet of the particle filter and is fluidically coupled to the vacuum pump through an outlet of the particle filter. In certain examples, the particle filter further comprises a receptacle configured to receive the removed particles. In other examples, the vacuum pump is configured as a roughing vacuum pump. In some instances, an inner diameter of the inlet of the particle filter is sized to be substantially similar to (or the same as) an inner diameter of the outlet of the particle filter to provide a substantially constant fluidic conductance through the vacuum manifold over a first period. In certain examples, each of the inlet of the particle filter and the outlet of the particle filter comprises a valve configured to alter an inner diameter of the inlet and an inner diameter of the outlet to permit a selectable fluidic conductance through the vacuum manifold. In other examples, the particle filter comprises a cyclonic particle separator and a receptacle fluidically coupled to the cyclonic particle separator, wherein the receptacle is configured to receive the removed particles. In some instances, the mass spectrometer comprises a valve fluidically coupled to the cyclonic particle separator and the receptacle, wherein the valve is configured to actuate to a closed position to permit removal of the receptacle without any substantial change in vacuum pressure in the vacuum manifold. In some examples, the particle filter is positioned external to a housing of the mass spectrometer. In other embodiments, the mass spectrometer comprises a second particle filter fluidically coupled to the particle filter. In some examples, the particle filter is configured as an electrostatic screen or a venturi scrubber.

In another aspect, a kit comprising a particle filter configured to remove particles from a fluid feed provided to a vacuum pump that can lower pressure in a system to less than atmospheric pressure, the particle filter positioned between the system and an inlet of the vacuum pump to remove particles from the fluid in the system prior to the fluid entering into the vacuum pump inlet without using any filtration media, and written or electronic instructions for using the particle filter in a mass spectrometer to filter a fluid of particles prior to the fluid being provided to a pump of the mass spectrometer. In some examples, the particle filter is configured to couple in-line between a vacuum manifold and a roughing pump.

In another aspect, a particle filter for use with a mass spectrometer is described. For example, the mass spectrometer may comprise a vacuum pump or pumps fluidically coupled to a vacuum manifold and configured to pump fluid from the vacuum manifold to reduce pressure within the vacuum manifold. The mass spectrometer can comprise a particle filter configured to remove particles in the fluid prior to entry of the fluid into the vacuum pump. In some examples, the particle filter is configured to remove particles without using any filtration media. In other instances, the particle filter is fluidically coupled to the vacuum manifold through an inlet of the particle filter and is fluidically coupled to the vacuum pump through an outlet of the particle filter.

In certain embodiments, the particle filter further comprises a receptacle configured to receive the removed particles, e.g., a receptacle that can be removed and cleaned/emptied. In other embodiments, the vacuum pump is configured as a roughing vacuum pump.

In some examples, an inner diameter of the inlet of the particle filter is sized to be substantially similar to (or the same as) an inner diameter of the outlet of the particle filter to provide a substantially constant fluidic conductance through the vacuum manifold over a first period.

In other examples, each of the inlet of the particle filter and the outlet of the particle filter comprises a valve configured to alter an inner diameter of the inlet and an inner diameter of the outlet to permit a selectable fluidic conductance through the vacuum manifold.

In some embodiments, the particle filter comprises a cyclonic particle separator and a receptacle fluidically coupled to the cyclonic particle separator, wherein the receptacle is configured to receive the removed particles. In other examples, a valve fluidically coupled to the cyclonic particle separator and the receptacle can be present, wherein the valve is configured to actuate to a closed position to permit removal of the receptacle without any substantial change in vacuum pressure in the vacuum manifold.

In some examples, the particle filter is positioned external to a housing of the mass spectrometer, e.g., to facilitate easy removal and cleaning of any associated particle receptacle.

In certain embodiments, a second particle filter may be present and fluidically coupled to the particle filter.

In some examples, the particle filter can be configured as an electrostatic screen or a venturi scrubber.

In certain examples, the mass spectrometer may comprise a sample introduction device, an ionization source/device, a reaction/collision cell, one or more mass analyzers and a detector, wherein the sample introduction device is fluidically coupled to the ionization source, wherein the ionization source is fluidically coupled to the mass analyzer through a differentially pumped interface and ion focusing optics, wherein the mass analyzer is fluidically coupled to the detector, and wherein the mass analyzer(s), the reaction/collision cell, the detector, and other focusing optics are housed in a vacuum manifold or chamber.

In certain embodiments, the ionization device comprises an inductively coupled plasma. In other embodiments, the mass analyzer comprises at least one quadrupole. In some examples, the detector comprises an electron multiplier.

In some embodiments, the vacuum manifold is fluidically coupled to a roughing vacuum pump and a turbomolecular pump, and the particle filter is present in a foreline between the vacuum manifold and the roughing vacuum pump.

In some examples, the particle filter comprises a cyclonic particle separator fluidically coupled to the vacuum manifold through an inlet of the cyclonic particle separator and fluidically coupled to an inlet of the roughing vacuum pump through an outlet of the cyclonic particle separator, and wherein the inlet of the cyclonic particle separator comprises a substantially similar inner diameter as an inner diameter of the outlet of the cyclonic particle separator.

In other examples, the particle filter comprises an electrostatic screen.

In certain examples, the particle filter comprises a venturi scrubber.

In additional examples, the detector of the mass spectrometer comprises a time of flight device.

In another aspect, a vacuum system comprising a vacuum pump and a particle filter upstream of an inlet of the vacuum pump is described. In some instances, the particle filter can be configured to remove particles in a fluid prior to entry of the fluid into the vacuum pump. In some embodiments, the particle filter is configured to remove particles without using any filtration media.

In certain examples, the particle filter comprises a cyclonic particle separator. For example, an inlet of the cyclonic particle separator can comprise a substantially similar inner diameter as an inner diameter of an outlet of the cyclonic particle separator. In other examples, the particle filter comprises an electrostatic screen. In further examples, the particle filter comprises a venturi scrubber.

In an additional aspect, a vacuum system may comprise a vacuum pump and a particle filter upstream of an inlet of the vacuum pump, wherein the particle filter is configured to remove particles in a fluid prior to entry of the fluid into the vacuum pump comprises a cyclonic particle separator.

In some examples, the vacuum system may comprise a receptacle fluidically coupled to the cyclonic particle separator, wherein the receptacle is configured to receive the removed particles.

In other examples, the vacuum system can comprise a valve fluidically coupled to the cyclonic separator and the receptacle, wherein the valve is configured to actuate between an open position and a closed position, and wherein in the closed position the receptacle can be removed without breaking the vacuum in the vacuum system.

In some embodiments, the vacuum pump is configured as a diaphragm pump or a rotary vane pump.

In other embodiments, an outlet of the particle filter is directly coupled to an inlet of the vacuum pump without any intervening fluid lines.

In another aspect, a method comprises reducing pressure in a device using a vacuum pump or pumps fluidically coupled to the device by pumping fluid from the device through a particle filter positioned between the device and the vacuum pump, wherein the particle filter is configured to remove particles in the pumped fluid prior to the fluid entering into the vacuum pump by cyclonically separating the particles in the fluid, e.g., by separating the particles from other components of the fluid.

In an additional aspect, a method comprises reducing pressure in a mass spectrometer using a vacuum pump or pumps fluidically coupled to the mass spectrometer by pumping fluid from the mass spectrometer through a particle filter positioned between the mass spectrometer and the vacuum pump, wherein the particle filter is configured to remove particles in the pumped fluid prior to the fluid entering into the vacuum pump by cyclonically separating the particles in the fluid, e.g., by separating the particles from other components of the fluid. In some examples, the particle filter is present between a roughing vacuum pump and the mass spectrometer.

In another aspect, a method comprises reducing pressure in a device using a vacuum pump or pumps fluidically coupled to the device by pumping fluid from the device through a particle filter positioned between the device and the vacuum pump, wherein the particle filter is configured to remove particles in the pumped fluid prior to the fluid entering into the vacuum pump using an electrostatic screen to filter the particles in the fluid.

In an additional aspect, a method comprises reducing pressure in a mass spectrometer using a vacuum pump or pumps fluidically coupled to the mass spectrometer by pumping fluid from the mass spectrometer through a particle filter positioned between the mass spectrometer and the vacuum pump, wherein the particle filter is configured to remove particles in the pumped fluid prior to the fluid entering into the vacuum pump using an electrostatic screen to filter the particles in the fluid. In some configurations, the particle filter is present between a roughing vacuum pump and the mass spectrometer.

In another aspect, a method comprises reducing pressure in a device using a vacuum pump or pumps fluidically coupled to the device by pumping fluid from the device through a particle filter positioned between the device and the vacuum pump, wherein the particle filter is configured to remove particles in the pumped fluid prior to the fluid entering into the vacuum pump using a venturi scrubber to filter the particles in the fluid.

In an additional aspect, a method comprises reducing pressure in a mass spectrometer using a vacuum pump or pumps fluidically coupled to the mass spectrometer by pumping fluid from the mass spectrometer through a particle filter positioned between the mass spectrometer and the vacuum pump, wherein the particle filter is configured to remove particles in the pumped fluid prior to the fluid entering into the vacuum pump using a venturi scrubber to filter the particles in the fluid. In some examples, the particle filter is present between a roughing vacuum pump and the mass spectrometer.

In another aspect, a method of facilitating protection of a vacuum pump or pumps in a mass spectrometer is provided. For example, the method comprises providing a particle filter configured to remove particles in a fluid pumped from the mass spectrometer by the vacuum pump, wherein the particle filter does not include any filtration media, and providing instructions for using the particle filter to protect the vacuum pump. In some embodiments, the providing instructions step comprises providing instructions for using the particle filter with a roughing vacuum pump.

In an additional aspect a method of facilitating protection of a vacuum pump or pumps in a mass spectrometer comprises providing a particle filter configured to remove particles in a fluid pumped from the mass spectrometer by the vacuum pump, wherein the particle filter comprises a cyclonic particle separator, and providing instructions for using the particle filter to protect the vacuum pump during operation of the mass spectrometer. In certain examples, the providing instructions step comprises providing instructions for using the particle filter with a roughing vacuum pump.

In another aspect, a method of facilitating protection of a vacuum pump or pumps in a mass spectrometer comprises providing a particle filter configured to remove particles in a fluid pumped from the mass spectrometer by the vacuum pump, wherein the particle filter comprises a electrostatic screen, and providing instructions for using the particle filter to protect the vacuum pump during operation of the mass spectrometer. In some embodiments, the providing instructions step comprises providing instructions for using the particle filter with a roughing vacuum pump.

In an additional aspect, a method of facilitating protection of a vacuum pump in a mass spectrometer comprises providing a particle filter configured to remove particles in a fluid pumped from the mass spectrometer by the vacuum pump, wherein the particle filter comprises a venturi scrubber, and providing instructions for using the particle filter to protect the vacuum pump during operation of the mass spectrometer. In some examples, the providing instructions step comprises providing instructions for using the particle filter with a roughing vacuum pump.

In another aspect, a particle filter configured to remove particles in a fluid prior to the fluid entering a vacuum pump or pumps, e.g., a vacuum pump of a mass spectrometer, is disclosed. In some embodiments, the particle filter comprises one or more of a cyclonic particle separator, an electrostatic screen or a venturi scrubber positioned inline and upstream of a vacuum pump inlet. In some examples, the particle filter is configured to remove particles from the fluid prior to the fluid entering into the vacuum pump inlet.

Additional features, configurations, examples and configurations are described in more detail below.

### BRIEF DESCRIPTION OF THE SEVERAL VIEWS OF THE DRAWINGS

Certain specific configurations are described in reference to the accompanying figures in which:

FIG. 1A is a block diagram of a particle filter fluidically coupled to a vacuum pump, in accordance with some configurations;

FIG. 1B is a block diagram of two particle filters fluidically coupled to a vacuum pump, in accordance with some configurations;

FIG. 2 is a block diagram of a particle filter fluidically coupled to a vacuum pump where the particle filter comprises a receptacle, in accordance with some configurations;

FIG. 3 is an illustration of a particle filter comprising a cyclonic separator, in accordance with some embodiments;

FIG. 4 is an illustration of a particle filter comprising an electrostatic filter, in accordance with some configurations;

FIG. 5 is an illustration of a particle filter comprising a venturi scrubber, in accordance with certain examples;

FIG. 6 is a block diagram showing a roughing or foreline pump, a turbomolecular pump and a mass analyzer, in accordance with some embodiments;

FIG. 7 is a block diagram showing certain components of a mass spectrometer, in accordance with certain embodiments;

FIG. 8 is a diagram showing a particle filter positioned external to an instrument housing, in accordance with certain embodiments;

FIG. 9 is a block diagram of a vacuum deposition system, in accordance with certain configurations;

FIG. 10 is a block diagram of a freeze drying apparatus, in accordance with some examples;

FIG. 11 is a flow chart showing how the particle filters described herein can be used, in accordance with some examples;

FIG. 12 is an illustration of a particle filter comprising a cyclonic chamber, a valve, and a receptacle, in accordance with some examples;

FIG. 13A is an illustration of a particle filter and FIG. 13B is a cross-section of the particle filter of FIG. 13A, in accordance with some embodiments;

FIGS. 14A, 14B, 14C and 14D are illustrations of simulations performed using a particle filter and particles with different average particle diameters, in accordance with some examples.

It will be recognized by the skilled person, given the benefit of this disclosure, that the components in the figures are not necessarily shown to scale and are not intended to be construed as showing all components that might be present in any system or device. Certain illustrative diagrams and schematics are shown to describe some of the novel and inventive attributes and features of the technology described herein, and many components may be omitted to increase clarity and provide a more user friendly description of various configurations.

### DETAILED DESCRIPTION

In certain configurations, the particle filters described herein can advantageously protect a fluidically coupled vacuum pump from receiving at least some, or even all, of the particles in a fluid stream to protect the vacuum pump components. The term “fluidically coupled” refers to two or more components which are connected in some manner such that a fluid can flow from one component to the other. While not required, a typical fluidic coupling includes a fluid line that physically connects the two components. In some instances, the particle filter does not include any filtration medium but is instead configured to use physical forces to remove the particles from the fluid stream. Various examples of particle filters are described in more detail below. The particle filters can be designed to remove particles, particulate matter and other solid or semi-solid materials that may be present (e.g., suspended or entrained) in a fluid such as a liquid or gas being drawn away from one device and into a vacuum device such as, for example, a vacuum pump. Particles of many different sizes including particles below 10 microns in diameter and above 10 microns in diameter can be removed from the fluid. The overall size, shape and geometry of the particle filter, the particle filter inlet, the particle filter outlet and other components or areas of the particle filter may vary as desired or based on removal of a certain size or size range of particles from the fluid. In the context of mass spectrometry, the fluid pumped by the vacuum pump typically is a gas that may comprise analyte ions/atoms and other species.

In certain embodiments, fluid pumped out of various devices may include acidic or basic materials that can combine downstream with other molecules to produce salts that can precipitate out. For example, in some analytical applications, analysis of highly acidic samples can introduce certain anions into the system at high concentrations. These anions can combine with cations, e.g., at an interface or in a vacuum manifold, present in other parts of the system to produce a salt that can precipitate out. Production of the salt can alter the fluid flow, e.g., fluidic conductance, through the system and can also result in the salt ending up in the vacuum pump itself.

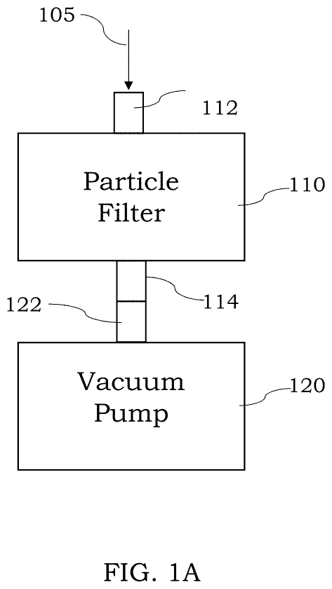

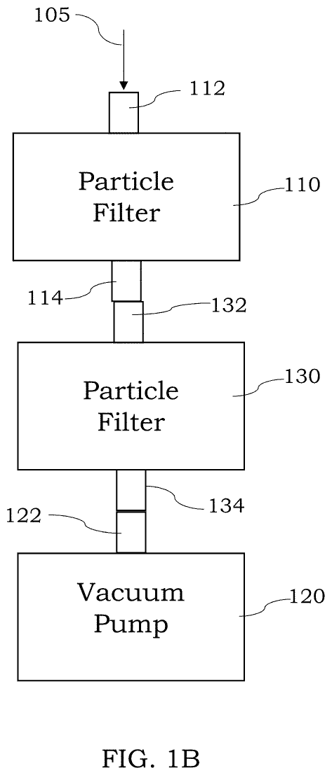

In some examples and referring to FIG. 1A, a simplified block diagram is shown of a particle filter 110 fluidically coupled to a vacuum pump 120. As shown, a fluid stream typically enters the particle filter 110 through an inlet 112 and exits the particle filter 110 through an outlet 114. An inlet 122 of the pump 120 is fluidically coupled to the outlet 114 of the particle filter 110. The vacuum pump 120 is downstream of the particle filter 110 in that fluid first enters into the particle filter 110 prior to being provided to the vacuum pump 120. Similarly, the particle filter 110 is upstream of the vacuum pump 120 since the fluid first enters into the filter 110 prior to being provided to the pump 120. In use of the particle filter 110, a fluid is drawn to enter the particle filter 110 (as shown by the arrow 105) through the inlet 112 as a result of negative pressure being provided by the vacuum pump 120. The fluid which enters into the particle filter 110 may comprise particles, particulate matter or suspended solid material that could enter into and damage the vacuum pump 120 over time. The particle filter 110 is configured to remove at least some of the particles, e.g., substantially all of the particles, in the fluid prior to the fluid being pulled into the inlet 122 of the vacuum pump 120 and then being discharged through an outlet (not shown) of the vacuum pump 120. By using a particle filter 110 positioned upstream of the vacuum pump 120, the fluid that enters into the vacuum pump 120 can be substantially free of particles to protect the vacuum pump 120. In certain examples, the particle filter 110 may be configured to remove particles without using any filtration media. In other instances, particles of a desired size or size range, e.g., particles above a certain average particle diameter or below a certain average particle diameter or within an average particle diameter range, can be removed by the particle filter 110.

In certain examples, an inner diameter of the inlet 112 can be about the same size and/or shape or geometry as an inner diameter of the outlet 114. Without wishing to be bound by any particular theory or any one specific configuration, by sizing the inner diameters of the particle filter inlet and the particle filter outlet to be about the same, the conductance through a system fluidically coupled to the particle filter does not change substantially over time. In contrast, with conventional filters that use a filtration media, such as aluminosilicates or zeolite or other materials, as the filtration media becomes packed with particles, the fluidic conductance changes over time. This conductance change can be particularly undesirable when the particle filter is present in a mass spectrometer to measure/detect ions. In other instances, the shape, size and/or geometry of the inlet 112 and the outlet 114 can be different. For example, it may be desirable to have a different shape for the inlet 112 than the outlet 114 to assist in filtering out particles of a certain size or to better control introduction of particles into the particle filter 110. Illustrative inlet and outlet cross-sectional shapes independently include, but are not limited to, circular, square, rectangular, elliptical, triangular, tetrahedral, trapezoidal, pentagonal, hexagonal or other shapes.

In certain examples, if desired two or more particle filters can be arranged in series or parallel to increase filtering efficiency. One illustration is shown in FIG. 1B, where a second particle filter 130 comprising an inlet 132 and an outlet 134 is shown in-line with the particle filter 110 and the vacuum pump 120. The particles filters 110, 130 can be the same or can be different. In some instances, each of the particle filters may operate using the same separation methodology, e.g., using cyclonic particle separation, but may be sized differently. In some examples, each of the particle filters 110, 130 can separate or filter particles without using any filtration media. If desired, however, one of the particle filters 110, 130 could include a filtration medium.

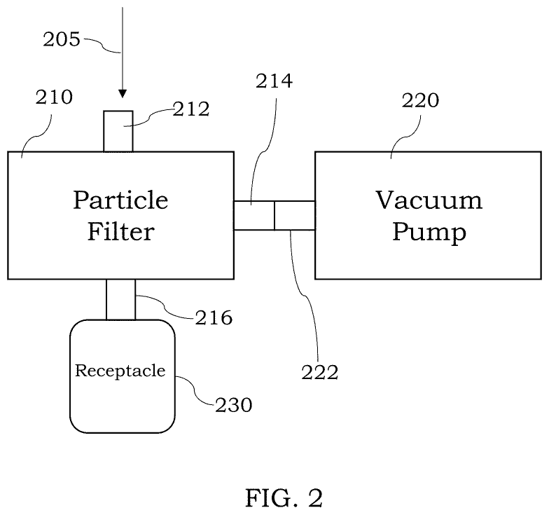

In certain embodiments, the particle filter may comprise a receptacle or other container or device that can receive the filtered particles. Referring to FIG. 2, a block diagram is shown of a particle filter 210 fluidically coupled to vacuum pump 220 through an outlet 214 of the filter and an inlet 222 of the vacuum pump 220. The particle filter 210 also comprises a receptacle 230 coupled to the particle filter 210 through a port 216. In use of the particle filter 210, the fluid can enter the filter 210 through the inlet 212 as shown by the arrow 205. The particle filter 210 is configured to remove the particles, e.g., without using any filtration media, and permit a residual fluid to enter into the vacuum pump 220 through the inlet 222. The removed particles can settle out or otherwise be provided to the receptacle 230 through the port 216. As noted in more detail below, the receptacle 230 can be removed periodically to remove the filtered particles. If desired, a valve or other device can be present in the port 216, or fluidically coupled to the port 216, to close the receptacle 230 off from the filter 210. This closing can permit removal of the receptacle 230 for emptying/cleaning without breaking the vacuum in the system. It is a substantial attribute that the particle filter can be cleaned without breaking the system vacuum. Conventional filtration media filters require breaking of the vacuum to remove and replenish the filtration media. Breaking of the vacuum requires significant downtime and mechanical efforts particularly in low pressure systems such as mass spectrometers, vacuum deposition devices, ion implantation devices and other devices and systems where some component or stage may operate at a pressure less than atmospheric pressure. In some embodiments, the receptacle 230 can be emptied or cleaned automatically, e.g., using a cleaning liquid and a processor to control the valve, to permit removal of any particles in an automated manner.

In some embodiments, the particle filters described herein can be configured to separate particles using cyclonic or vortex separation. For example, the particle filter may comprise a cyclonic particle separator that can use vortex separation to remove particles in the fluid. When removing particulate matter from a liquid, a hydrocyclone can be used, and when removing particles from a gas, a gas cyclone can be used. Without wishing to be bound by any particular theory or any one specific configuration, cyclonic particle separation can use rotational effects and in some cases gravity to filter out the particles from the fluid. In one configuration, a high-speed rotating air flow is provided in a cylindrical or conical container called a cyclone. Air flows in a helical pattern, beginning at the inlet and ending at the outlet. The fluid, less at least some of the removed particles, can exit the cyclone in a straight stream through the center of the cyclone and out the top (or other position of the separator). Larger (denser) particles in the rotating stream generally have too much inertia to follow the tight curve of the air stream, and thus strike the outside wall of the separator. These particles then fall or drop to the bottom of the cyclone where they can be removed, e.g., can be collected in a chamber or reservoir such as receptacle 230 shown in FIG. 2.

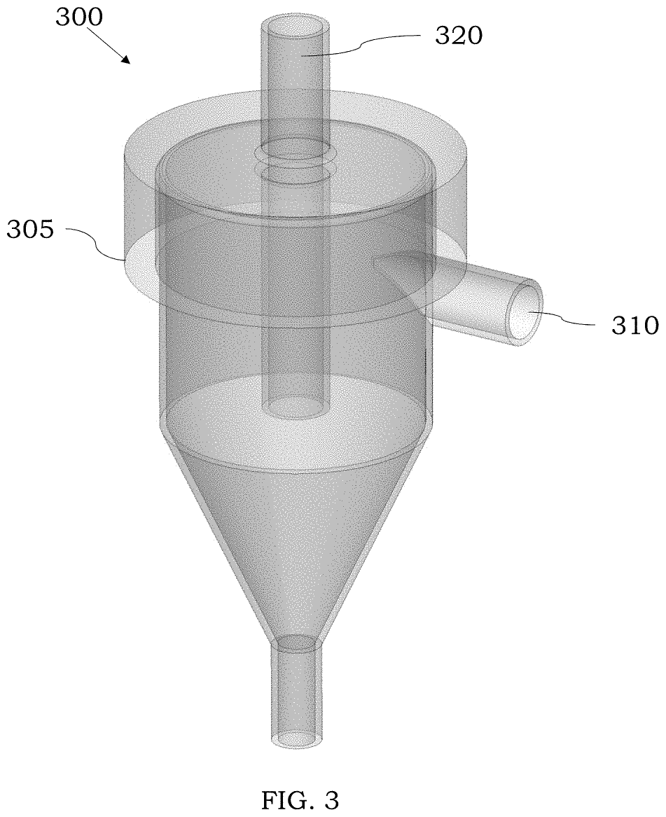

In some examples, one illustration of a cyclonic particle separator is shown in FIG. 3. The cyclonic separator 300 comprises a cyclonic chamber 305 comprising an inlet 310 and an outlet 320. As noted herein, an inner diameter of the inlet 310 may be about the same as the inner diameter of the outlet 320 such that a substantially constant fluidic conductance is present. While not shown, one or both of the inlet 310 and the outlet 320 may comprise a valve or other actuator which can alter the overall inner diameters of the inlet 310 or the outlet 320 or both. When the inner diameter of the inlet 310 is altered, it may be desirable to alter the inner diameter of the outlet 320 in a corresponding manner. The cyclonic chamber 305 can be used to remove at least some or substantially all of the particles from a fluid entering into the inlet 310 without using a filtration media. As shown by the dashed lines in FIG. 3, the outlet 320 can extend into the conical portion of the cyclonic chamber 305 to ensure fewer particles, e.g., substantially no particles, exit the cyclonic chamber 305 through the outlet 320. While a single cyclonic chamber 305 is shown in FIG. 3, two or more cyclonic chambers can be fluidically coupled to each other to enhance particle filtering in the fluid. For example, cyclonic chambers positioned at different angles or sized or shaped differently can be used to remove particles having a wide size distribution. In some instances, the chamber may comprise two, three, four or more different separation stages with downstream stages sized and arranged to remove smaller particles than the upstream stages. By removing different sized particles with different stages, substantially more particles in the fluid stream can be removed prior to the fluid entering into a vacuum pump.

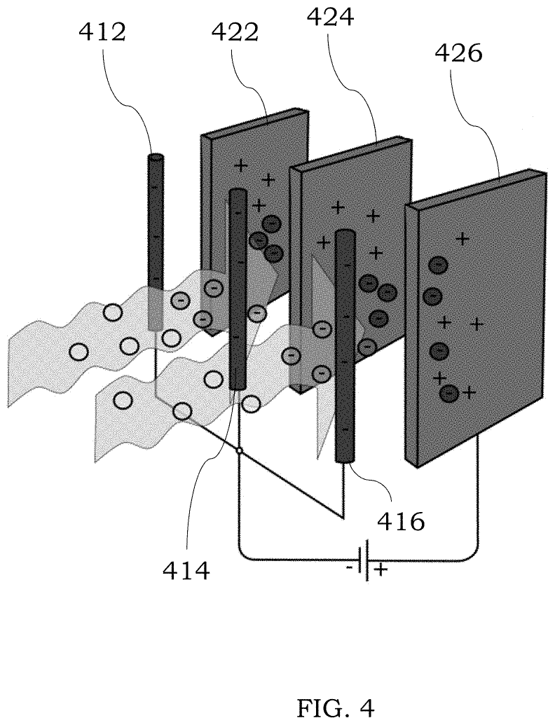

In some examples, a particle filter may comprise an electrostatic screen or electrostatic precipitator that can remove the particles from a fluid stream. Without wishing to be bound by any particular configuration, an electrostatic precipitator typically comprises a plurality of thin vertical wires followed by a stack of large flat metal plates oriented vertically. The exact plate spacing can vary with typical values being about 1 cm to about 18 cm apart. The fluid stream flows horizontally through the spaces between the wires, and then passes through the stack of plates. A negative voltage of several thousand volts can be provided between the wire and plate. If the applied voltage is high enough, an electric corona discharge ionizes the air around the electrodes, which then charges the particles in the fluid stream. The charged particles, due to the electrostatic force, are diverted towards the grounded plates. Particles build up on the collection plates and are removed from the fluid stream. In some cases, a two-stage design (separate charging section ahead of collecting section) can be present which can minimize the production of unwanted reaction products, e.g., ozone, that might adversely affect the vacuum pump. In some embodiments, an electrostatic precipitator can be used in combination with a cyclonic separator to enhance removal of particles in a fluid stream. Referring to FIG. 4, a simplified illustration of an electrostatic filter is shown. The electrostatic filter comprises wires 412, 414 and 416 arranged adjacent to a series of plates 422, 424 and 426, respectively. The voltage differential between the plates 422, 424 and 426 and wires 412, 414 and 416 causes particles to build up on the plates 422, 424 and 426, which removes the particles from the incoming fluid stream. The exact size and shape of the wires and the plates may vary and are not limited to those sizes and shapes shown in the illustration of FIG. 4. For example, round, square, elliptical or other shaped plates can be used. Similarly, the wires 412, 414, 416 may be coiled, solid or may comprise apertures or holes as desired.

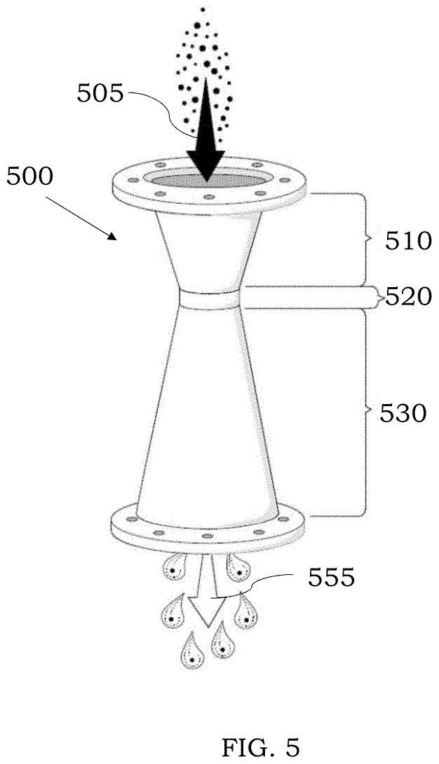

In other instances, the particle filters described herein may comprise one or more venturi scrubbers configured to remove particles from a fluid. A venturi scrubber is typically designed to use the energy from an inlet gas stream to atomize a liquid being used to scrub the gas stream. One illustration of a venturi scrubber is shown in FIG. 5. A venturi scrubber 500 comprises three sections including a converging section 510, a throat section 520, and a diverging section 530. An inlet fluid stream 505 enters the converging section 510 and, as the area decreases, gas velocity increases. Liquid is introduced either at the throat section 520 or at the entrance to the converging section 510. The inlet fluid is forced to move at extremely high velocities in the small throat section 520 and shears the liquid from its walls producing an enormous number of very tiny droplets. Particle removal can occur in the diverging section 530 as the inlet gas stream mixes with the fog of tiny liquid droplets. The inlet stream then exits through the diverging section 530 and slows down before it exits the device 500 as shown by arrow 555. In some examples, the atomized liquid provides a surface for the particles to impact on and be removed. These liquid droplets incorporating the particles can be removed from the outlet stream using, for example, a cyclonic separator and the resulting fluid stream, which has fewer or no particles, may then be permitted to enter into a vacuum pump.

In some embodiments, the particle filters described herein can be used with many different type of vacuum pumps including, but not limited to, a positive displacement pump, a momentum transfer pump, a regenerative pump, an entrapment pump or other types of vacuum pumps.

In some examples, the vacuum pump is configured as a diaphragm pump. A diaphragm pump is a positive displacement pump that uses a reciprocating action of a flexing diaphragm to move fluid into and out of a pumping chamber. The flexing diaphragm provides a vacuum at the inlet of the chamber that draws the fluid into the chamber.

In other examples, the vacuum pump is configured as a rotary vane pump. In one instance, a rotary van pump comprises a circular rotor rotating inside a larger circular cavity. The centers of these two circles are offset, causing eccentricity. Vanes are allowed to slide into and out of the rotor and seal on all edges, providing vane chambers that provide the pumping. On the intake side of the pump, the vane chambers are increasing in volume. These increasing-volume vane chambers are filled with fluid forced in by the inlet pressure. On the discharge side of the pump, the vane chambers are decreasing in volume, forcing fluid out of the pump. The action of the vane drives out the same volume of fluid with each rotation. If desired, the rotary vane pump can be configured as a multistage rotary-vane vacuum pump.

In another example, the vacuum pump can be configured as a piston pump. A piston pump is a positive displacement pump that uses pistons driven by a crankshaft to deliver gases at high pressure. The intake gas enters the suction manifold, then flows into the compression cylinder where it gets compressed by a piston driven in a reciprocating motion via a crankshaft and is then discharged.

In further examples, the vacuum pump can be configured as a liquid-ring pump. The liquid-ring pump can compress gas by rotating a vaned impeller located eccentrically within a cylindrical casing. Liquid (usually water) is fed into the pump and, by centrifugal acceleration, forms a moving cylindrical ring against the inside of the casing. This liquid ring creates a series of seals in the space between the impeller vanes, which form compression chambers. The eccentricity between the impeller's axis of rotation and the casing geometric axis results in a cyclic variation of the volume enclosed by the vanes and the ring. Gas can be drawn into the pump through an inlet port in the end of the casing. The gas is trapped in the compression chambers formed by the impeller vanes and the liquid ring. The reduction in volume caused by the impeller rotation compresses the gas, which is provided to the discharge port in the end of the casing.

In other examples, the vacuum pump may comprise one or more scrolls. In one configuration, a scroll pump comprises two interleaving scrolls to pump, compress or pressurize fluids such as liquids and gases. The vane geometry may be involute, Archimedean spiral, hybrid curves or take other shapes. In a typical configuration, one of the scrolls is fixed while the other orbits eccentrically without rotating. This action acts to trap and pump pockets of fluid between the scrolls. Another configuration for producing the compression motion is co-rotating scrolls, in synchronous motion, but with offset centers of rotation. The relative motion is the same as if one were orbiting. Another variation comprises flexible tubing where the Archimedean spiral functions as a peristaltic pump.

In another configuration, the vacuum pump can be configured as a Roots type pump. A Roots type pump is a positive displacement lobe pump which operates by pumping a fluid with a pair of meshing lobes similar to a set of stretched gears. Fluid is trapped in pockets surrounding the lobes and carried from the intake side to the exhaust.

In certain embodiments, the particle filters described herein can be used as a particle filter for one or more vacuum pumps in a system where one or more of the stages or components operates at a pressure below atmospheric pressure. For example, the particle filers described herein can be used with a mass spectrometer system, e.g., can be used with a roughing pump or foreline pump. The vacuum systems of many MS systems comprise differentially pumped system including a foreline pump establishing a “rough” vacuum and a high vacuum pump or pumps, e.g., a turbomolecular pump, diffusion pump, cryopump, etc., situated on the mass analyzer body to establish high levels of vacuum used for mass-to-charge (m/z) ratio measurements. Without wishing to be bound by any one configuration, a foreline or roughing pump typically functions to reduce the pressure within a particular region of the mass spectrometer to approximately 1 Pascal (10⁻² Torr) prior to the high vacuum pump(s) establishing a desired mass analyzer pressure. The roughing pump can be configured as many different types of vacuum pumps such as those described herein, e.g., an oil-sealed rotary vane pump that comprises a piston on an eccentric drive shaft that rotates in a compression chamber sealed by spring-loaded vanes, moving gas from the inlet side to the exhaust port. The high vacuum created in post skimmer regions, e.g., regions downstream of the skimmers and closer to the selection stages of the mass spectrometer, can typically be achieved using a turbomolecular pump, which can be configured in many different ways and is often configured as a pump that comprises a plurality of rotating foils or blades that are angled to compress exiting molecules and progressively draw them down through the stack and out via the vent port. The turbomolecular pump often spins at very high rpms, e.g., 60,000 rpms or more. The turbomolecular pump could also be configured, for example, as an oil diffusion pump, an oil free diffusion pump, or a cryogenic pump if desired. If desired more than one turbomolecular pump may be present in the system to assist in controlling the pressures in the mass analyzer.

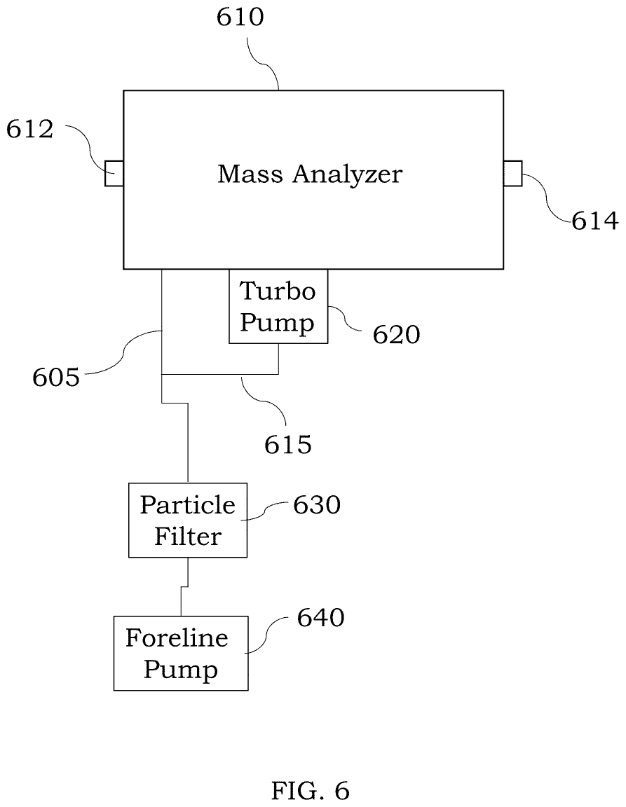

In certain embodiments and referring to FIG. 6, a simplified illustration of certain components of a mass spectrometer is shown. The mass analyzer 610 typically comprises one or more stages or components (as discussed further below) to separate and/or select ions/atoms entering into the mass analyzer through an inlet 612. The selected ions/atoms can be provided to a downstream component such as a detector through an outlet 614. A vacuum is present in the mass analyzer with the vacuum pressure generally decreasing from the inlet 612 toward the outlet 614 of the mass analyzer 610. The vacuum pressure can be provided using a foreline pump 640 and one or more high vacuum pumps, e.g., a diffusion pump, a cryopump or a turbomolecular pump, such as pump 620. The foreline pump 640 and turbomolecular pump 620 are typically each fluidically coupled to a vacuum manifold at different ports. For example, the foreline pump 640 can be fluidically coupled to the mass analyzer 610 through a foreline 605. In use of the components shown in FIG. 6, the foreline pump 640 typically lowers the pressure in the mass spectrometer system to a certain level, e.g., 10⁻² Torr. One or more valves present between the turbomolecular pump 620 and the vacuum manifold can then be opened to permit further pumping down of pressures, e.g., to 10⁻⁶ Torr or less. The foreline pump 640 can be fluidically decoupled from the vacuum manifold if desired by closing a valve between the vacuum manifold and the foreline pump 640. The turbomolecular pump 620 can then provide the high vacuum used in downstream stages of the mass analyzer 610 to select ions based on m/z ratios. The foreline pump 640 also is typically used to “back” the turbomolecular pump 620 through the fluidic line 615 that fluidically couples the foreline pump 640 to the turbomolecular pump 620. For example, a backing valve (not shown) in the fluid line 615 can be present between the foreline pump 640 and the turbomolecular pump 640 and opened to permit the foreline pump 640 to decrease pressure in the fluidic lines of the system. While not specifically shown in FIG. 6, the backing valve is typically upstream of the particle filter 630. A particle filter 630 as described herein can be present between the foreline pump 640 and the mass analyzer 610 to remove particles from the fluid prior to the fluid entering into the foreline pump 640. As discussed herein, the particle filter 630 may comprise one or more of a cyclonic particle separator, an electrostatic filter, a venturi scrubber or other particle separation device that does not comprise any filtration media. If desired, a device comprising a filtration medium may also be used with the particle filter 630.

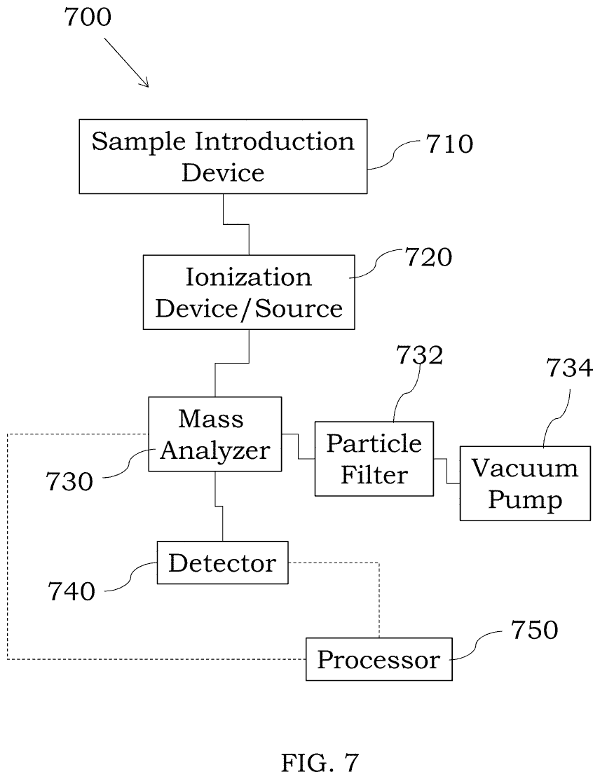

In certain embodiments, the particles filters described herein may be present in a mass spectrometer system comprising many different components or stages. One illustration is shown in FIG. 7 where the mass spectrometer 700 comprises a sample introduction device 710, an ionization device 720, a mass analyzer 730 and a detector 740. As noted herein, a particle filter 732 can be fluidically coupled to the system 700, e.g., through the mass analyzer 730 or other component or area of the system 700, and to a vacuum pump 734 to remove particle in a fluid prior to the fluid entering into the vacuum pump 734.

In certain examples, the sample introduction device 710 can be configured as an induction nebulizer, a non-induction nebulizer or a hybrid of the two, a concentric, cross flow, entrained, V-groove, parallel path, enhanced parallel path, flow blurring or piezoelectric nebulizers, a spray chamber, a chromatography device such as a gas chromatography device or other devices that can provide a sample to the ionization device 720.

In some configurations, the ionization device/source 720 may comprise many different types of devices that can receive a fluid from the sample introduction device 710 and ionize/atomize analyte in the fluid sample. In some examples, the ionization device 720 may comprise an inductively coupled plasma that can be produced using a torch and an induction device, a capacitively coupled plasma, an electron ionization device, a chemical ionization device, a field ionization source, desorption sources such as, for example, those sources configured for fast atom bombardment, field desorption, laser desorption, plasma desorption, thermal desorption, electrohydrodynamic ionization/desorption, etc., thermospray or electrospray ionization sources or other types of ionization sources. Notwithstanding that many different types of ionization devices/sources 720 can be used, the ionization device/source 720 typically ionizes analyte ions in the sample and provides them in a fluid beam downstream to the mass analyzer 730 where the ions/atoms can be separated/selected based on different mass-to-charge ratios. Various types of ionization devices/sources and associated componentry can be found, for example, in commonly assigned U.S. Pat. Nos. 10,096,457, 9,942,974, 9,848,486, 9,810,636, 9,686,849 and other patents currently owned by PerkinElmer Health Sciences, Inc. (Waltham, Mass.) or PerkinElmer Health Sciences Canada, Inc. (Woodbridge, Canada).

In some examples, the mass analyzer 730 may take numerous forms depending generally on the sample nature, desired resolution, etc. and exemplary mass analyzers may comprise one or more rod assemblies such as, for example, a quadrupole or other rod assembly. The mass analyzer 730 may comprise one or more cones, e.g., a skimmer cone, sampling cone, an interface, ion guides, collision cells, lenses and other components, that can be used to sample an entering beam received from the ionization device/source 720. The various components can be selected to remove interfering species, remove photons and otherwise assist in selecting desired ions from the entering fluid comprising the ions. In some examples, the mass analyzer 730 may be, or may include, a time of flight device. In some instances, the mass analyzer 730 may comprise its own radio frequency generator. In certain examples, the mass analyzer 730 can be a scanning mass analyzer, a magnetic sector analyzer (e.g., for use in single and double-focusing MS devices), a quadrupole mass analyzer, an ion trap analyzer (e.g., cyclotrons, quadrupole ions traps), time-of-flight analyzers (e.g., matrix-assisted laser desorbed ionization time of flight analyzers), and other suitable mass analyzers that can separate species with different mass-to-charge ratios. If desired, the mass analyzer 730 may comprise two or more different devices arranged in series, e.g., tandem MS/MS devices or triple quadrupole devices, to select and/or identify the ions that are received from the ionization device/source 720. As noted herein, the mass analyzer 730 can be fluidically coupled to a vacuum pump 734 through a particle filter 732 to provide the vacuum used to select the ions in the various stages of the mass analyzer 730. The vacuum pump 734 is typically a roughing or foreline pump as noted herein. The particle filter 732 may comprise one or more of a cyclonic particle separator, an electrostatic filter, a venturi scrubber or other particle separation device that does not comprise any filtration media. If desired, a device comprising a filtration medium may also be used with the particle filter 732. Various components that can be present in a mass analyzer 730 are described, for example, in commonly owned U.S. Pat. Nos. 10,032,617, 9,916,969, 9,613,788, 9,589,780, 9,368,334, 9,190,253 and other patents currently owned by PerkinElmer Health Sciences, Inc. (Waltham, Mass.) or PerkinElmer Health Sciences Canada, Inc. (Woodbridge, Canada).

In some examples, the detector 740 may be any suitable detection device that may be used with existing mass spectrometers, e.g., electron multipliers, Faraday cups, coated photographic plates, scintillation detectors, multi-channel plates, etc., and other suitable devices that will be selected by the person of ordinary skill in the art, given the benefit of this disclosure. Illustrative detectors that can be used in a mass spectrometer are described, for example, in commonly owned U.S. Pat. Nos. 9,899,202, 9,384,954, 9,355,832, 9,269,552, and other patents currently owned by PerkinElmer Health Sciences, Inc. (Waltham, Mass.) or PerkinElmer Health Sciences Canada, Inc. (Woodbridge, Canada).

In certain instances, the mass spectrometer system may also comprise a processor 750, which typically take the forms of a microprocessor and/or computer and suitable software for analysis of samples introduced into the mass spectrometer 700. The processor 750 may be present in the mass spectrometer 700 or outside of the mass spectrometer 700. While the processor 750 is shown as being electrically coupled to the mass analyzer 730 and the detector 740, it can also be electrically coupled to the other components shown in FIG. 7 to generally control or operate the different components of the system 700. In some embodiments, the processor 750 can be present, e.g., in a controller or as a stand-alone processor, to control and coordinate operation of the system 700 for the various modes of operation using the system 700. For this purpose, the processor can be electrically coupled to each of the components of the system 700, e.g., one or more pumps, one or more voltage sources, rods, etc., as well as any other voltage sources included in the system 700. If desired, the processor 750 can also be electrically coupled to the particle filter 732 to operate any valves present to permit draining/cleaning of any particle receptacle of the filter 732 without breaking the vacuum in the system 700.

In certain configurations, the processor 750 may be present in one or more computer systems and/or common hardware circuitry including, for example, a microprocessor and/or suitable software for operating the system, e.g., to control the voltages of the ion source, pumps, mass analyzer, detector, etc. In some examples, any one or more components of the system 700 may comprise its own respective processor, operating system and other features to permit operation of that component. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Motorola PowerPC, Sun UltraSPARC, Apple A series processors, Hewlett-Packard PA-RISC processors, or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, calibrations and data during operation of the system in the various modes using the gas mixture. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system 700. For example, computer control can be implemented to control the vacuum pressure, to close and open any valves present between the particle filter and an associated receptacle, etc. The processor typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface or the like or through one or more wireless interfaces, e.g., Bluetooth, Wi-Fi, Near Field Communication or other wireless protocols and/or interfaces.

In certain embodiments, the storage system used in the systems described herein typically includes a computer readable and writeable non-volatile recording medium in which codes can be stored that can be used by a program to be executed by the processor or information stored on or in the medium to be processed by the program. The medium may, for example, be a hard disk, solid state drive or flash memory. Typically, in operation, the processor causes data to be read from the non-volatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC) or a field programmable gate array (FPGA). Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware. In the systems, the processor is typically a commercially available processor such as the well-known Pentium class processors available from the Intel Corporation. Many other processors are also commercially available. Such a processor usually executes an operating system which may be, for example, the Windows 95, Windows 98, Windows NT, Windows 2000 (Windows ME), Windows XP, Windows Vista, Windows 7, Windows 8 or Windows 10 operating systems available from the Microsoft Corporation, MAC OS X, e.g., Snow Leopard, Lion, Mountain Lion or other versions available from Apple, the Solaris operating system available from Sun Microsystems, or UNIX or Linux operating systems available from various sources. Many other operating systems may be used, and in certain embodiments a simple set of commands or instructions may function as the operating system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C # (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the systems remotely as desired.

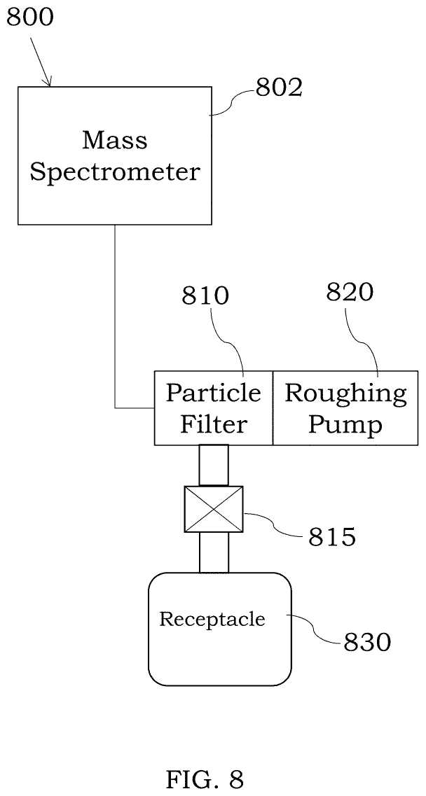

In some examples, the filters described herein can be present external to a housing of a mass spectrometer (or other system or device) to permit easy cleaning/emptying of the particle receptacle of the filter. A simplified illustration is shown in FIG. 8 where a mass spectrometer system 800 is fluidically coupled to a roughing pump 820 through a particle filter 810. The roughing pump 820 and the particle filter 810 are positioned external to a housing 802 of the mass spectrometer 800. If desired, the particle filter 810 can be mounted directly to an inlet of the roughing pump 820. A valve 815 can be present between a particle receptacle 830 and the particle filter 810 to permit the vacuum in the system to be maintained when the receptacle 830 is being cleaned/emptied. By positioning the particle filter 810 outside of the housing 802, the receptacle 830 can be easily cleaned/emptied. If desired, only the receptacle 830 can be positioned outside of the housing 802 and the other components can be present in the housing 802.

In certain embodiments, the particle filter can be operated at ambient temperature or may be cooled or heated to provide a desired effect. For example, a chamber of the particle filter can be cooled to act as a cold trap and slow particle velocity to enhance removal of the particles from the fluid and/or to condense and trap unwanted fumes or vapors that might otherwise damage the pump. Similarly, the chamber could be heated to increase particle velocity and promote collisions of the particles with the inner surfaces of the chamber. Temperature control can be provided, for example, using a thermoelectric cooler/heater, a heated gas, heating strips, a heating or cooling fluid jacket thermally coupled to the chamber or other devices and methods.

In certain examples, the particle filters described herein can be used in combination with one or more vacuum pumps to reduce the pressure within a device fluidically coupled to the vacuum pump. For example, the vacuum pump can pump fluid out of the device to reduce the pressure in the device. The pumped fluid may comprise particles, particulate matter or other species which could contaminate the vacuum pump and potentially reduce its lifetime and/or necessitate the need for increased oil changes or other servicing of the vacuum pump. The particle filter can be used to remove at least some, e.g., 50% or more, 60% or more, 70% or more, 80% or more, 90% or more, 95% or more, 98% or more, 99% or more or even substantially all of the particles in the fluid prior to the fluid entering into an inlet of the vacuum pump. The particle filter may comprise one or more of a cyclonic particle separator, an electrostatic screen, a venturi scrubber and combinations thereof. If desired, a particle filter comprising a filtration medium can be used in combination with a particle filter that does not include any filtration media. The various particles filters and combinations of them can be used with mass spectrometers or other high vacuum devices and systems. Further, the particle filter can be used with additional traps or filters such as solvent traps that can receive the fluid and provide it to a solvent system to remove certain acidic or basic gaseous species in the fluid.

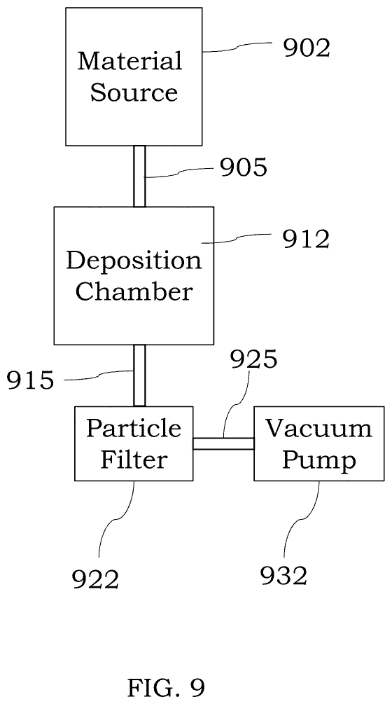

In certain embodiments, the particle filters described herein can be used with systems other than mass spectrometers. For example, the particle filter can be used in combination with a vacuum deposition system. Referring to FIG. 9, a block diagram is shown of a vacuum deposition device 900 that comprises a material source 902 fluidically coupled to a deposition chamber 912 through a fluid line 905. The deposition chamber 912 is fluidically coupled to a vacuum pump 932 through a particle filter 922 and fluid lines 915 and 925. In use, material from the material source 902 can be vaporized and provided to a substrate (not shown) within the deposition chamber 912. The material can be deposited onto the substrate generally though a “line of sight” trajectory between the material and the substrate. Illustrative material sources include, but are not limited, to metal wire coils, e.g., tungsten or other metals, that can be heated or impacted with energy to force emission of material from the material source 902. The emitted material is drawn into the deposition chamber 912 as a result of a vacuum pulled by the vacuum pump 932. Some particles or other material may be pulled through the deposition chamber 912 and can be filtered out by the particle filter 922 to protect the vacuum pump 932. The vacuum pump 932 can also be used to pump the system down to remove residual gas molecules prior to deposition so the emitted material is more likely to be deposited onto a surface of the substrate.

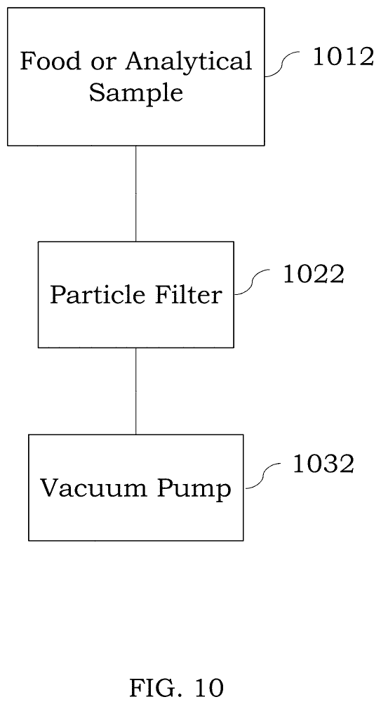

In another configuration, the particles filters described herein can be used in freeze drying devices, e.g., a lyophilizer. Without wishing to be bound by any one configuration, a freeze dryer can use a vacuum pump, e.g., an oil based rotary vane pump or a hybrid/combination vacuum pump, to remove water (or other solvent or liquids) from a material placed in a vacuum chamber. The solid water will undergo sublimation and be removed from the remaining solid material. The remaining solid material may be generally free of water and can be stored in an inert environment, e.g., under nitrogen, to preserve it. Analytical samples may also be frozen and lyophilized for storage, subsequent analysis or for other reasons. As shown in FIG. 10, a particle filter 1022 as described herein can be placed between a food sample 1012 and a vacuum pump 1032 to ensure solid material does not get to the vacuum pump 1032.

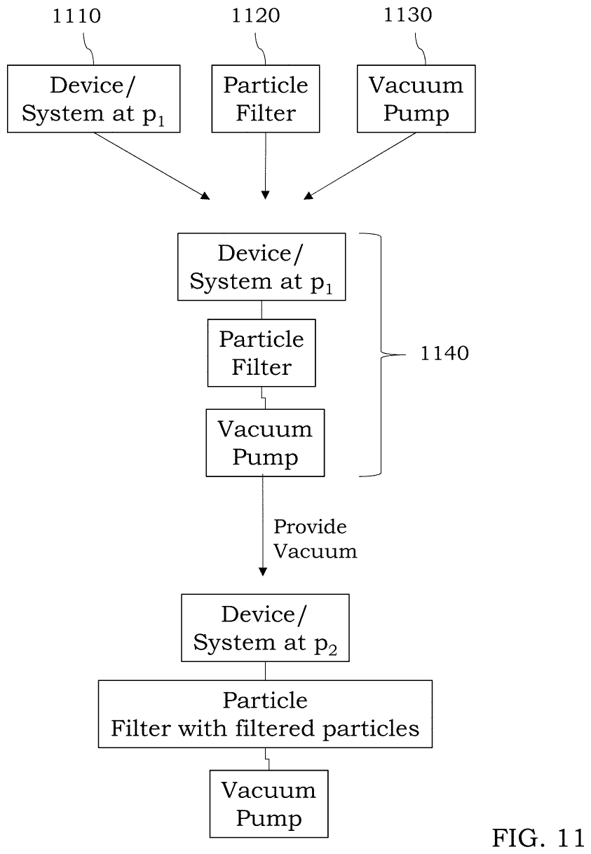

In certain instances, the particle filters described herein can be used in a process to lower pressure in another device or system. A flow chart is shown in FIG. 11, where a particle filter 1120 is coupled to a device 1110 and a vacuum pump 1130 to provide an assembly 1140. A vacuum can be provided by the vacuum pump 1130 through the particle filter to lower a pressure in the device from a first pressure p₁ to a second pressure p₂. Particles in the fluid drawn out of the device/system 1110 can be filtered out by the particle filter 1120 prior to the fluid entering into the vacuum pump 1130. As noted herein, a receptacle (not shown) may be fluidically coupled to the particle filter and can be used to collect the filtered particles. The device/system 1110 can be a mass spectrometer, vacuum deposition chamber, lyophilizer or other devices and systems that operate at a pressure below atmospheric pressure. The particle filter 1120 may be any one or more of a cyclonic particle separator, an electrostatic screen, a venturi scrubber or other particle separators. The vacuum pump 130 may be any of those pumps described herein or other suitable vacuum pumps. Additional steps may also be performed depending on the nature of the device/system 1110 and a desired end result.

In some examples, the particle filters described herein may be packaged in a kit to permit an end user to retrofit an existing device or instrument with the particle filter. For example, a kit may comprise a particle filter configured to remove particles from a fluid feed provided to a vacuum pump that can lower pressure in a system to less than atmospheric pressure, the particle filter positioned between the system and an inlet of the vacuum pump to remove particles from the fluid in the system prior to the fluid entering into the vacuum pump inlet without using any filtration media, and written or electronic instructions for using the particle filter with the device or system. In some examples, the written or electronic instruction may be designed to use the particle filter in a mass spectrometer to filter a fluid of particles prior to the fluid being provided to a pump of the mass spectrometer. In some examples, the particle filter is configured to couple in-line between a vacuum manifold and a roughing pump. A kit may also comprise different particle filters or particle filters of different sizes as desired.

Certain specific configurations of particle filters are described below to illustrate\additional features and aspects of the technology described herein.

### Example 1

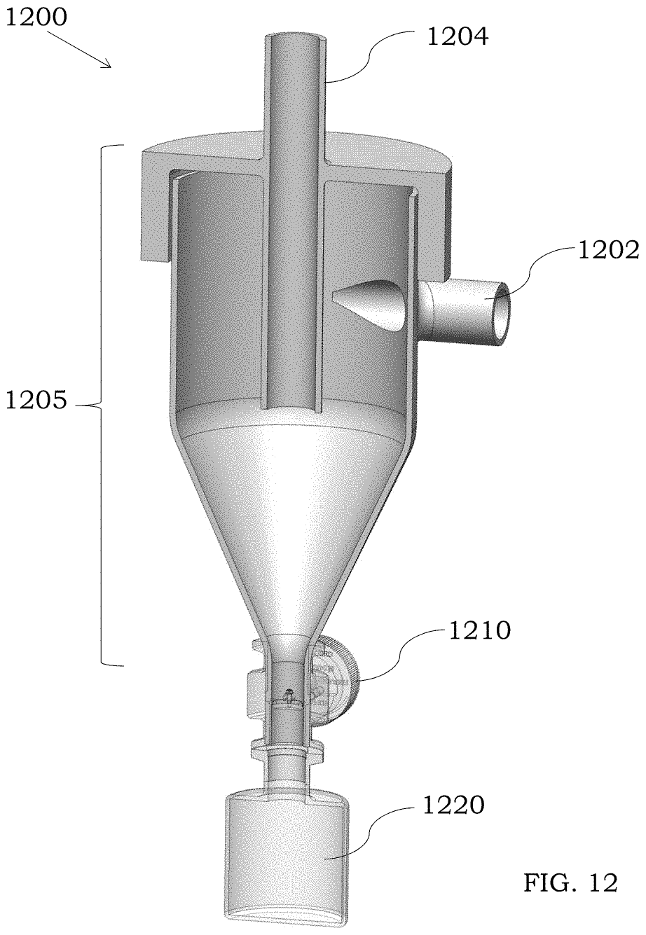

A particle filter comprising a cyclonic particle separator, a valve, and a receptacle can be produced and used in a mass spectrometer vacuum system. Referring to FIG. 12, a particle filter 1200 comprises an inlet 1202 and an outlet 1204. A chamber 1205 is present and comprises a generally cylindrical portion coupled to a funnel shaped portion. A valve 1210 is present and positioned between a terminal end of the funnel shaped portion of the chamber 1205 and a particle receptacle 1220. The valve 1210 may be a needle valve, solenoid valve, ball valve or take other forms. As noted herein, the valve 1220 can be closed to permit removal of the receptacle 1220 without breaking the vacuum on the system that the particle filter is present. The inlet 1202 can be sized and arranged to comprise about the same dimensions as the outlet 1204 to maintain a substantially similar fluidic conductance throughout the system in which the particle filter is present.

### Example 2

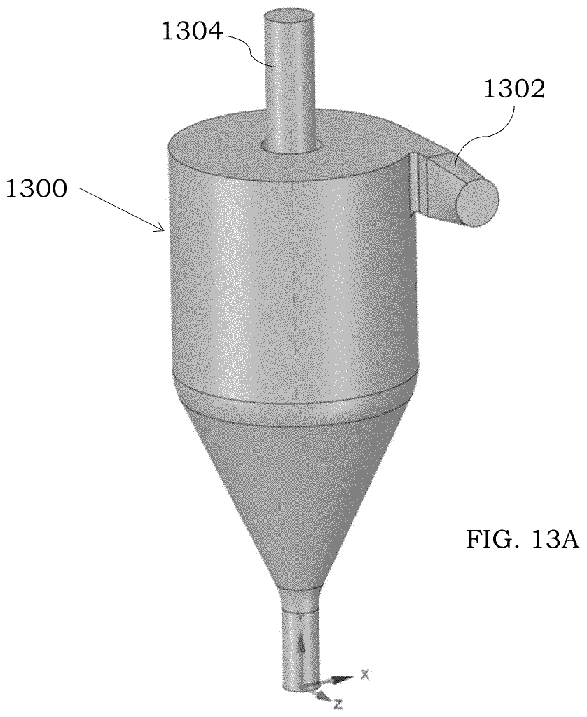

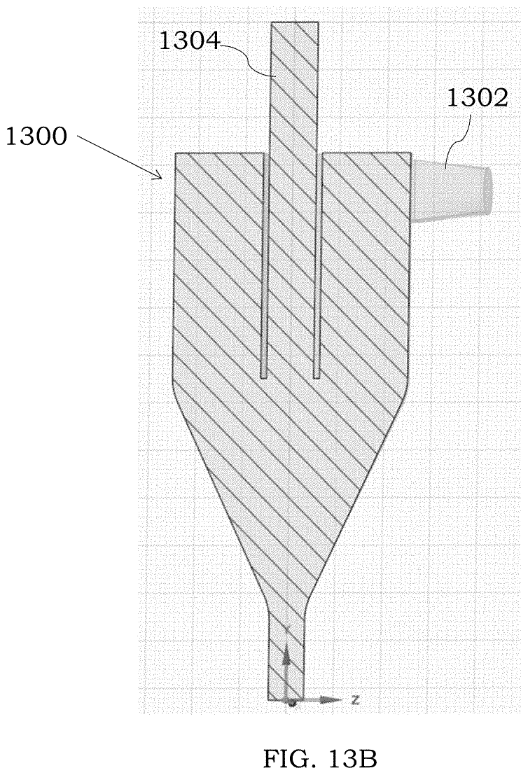

A particle filter 1300 (see FIG. 13A) and a cross-section of the particle filter 1300 (see FIG. 13B) are shown. An inlet 1302 with a trapezoidal shaped cross section (when viewed from the side of the inlet 302) is shown, though as noted herein, the exact shape and size of the inlet can vary. An outlet 1304 is shown as having a generally circular/cylindrical shape but other shapes are also possible. A particle filter with this trapezoidal shaped inlet was used to simulate filtering of particles using the filter 1300 as noted in the examples below.

### Example 3

ANSYS Fluent software (commercially available from Ansys in Canonburg, Pa.) was used to simulate particle filtering using the particle filter shown in FIGS. 13A and 13B. An inlet mass flow rate of 7×10⁻⁵ kg/s and an outlet pressure of 3 Torr were used in the simulations. Particles with sizes up to an average particle diameter of 50 microns were simulated for their ability to exit the filter through the outlet 1304.

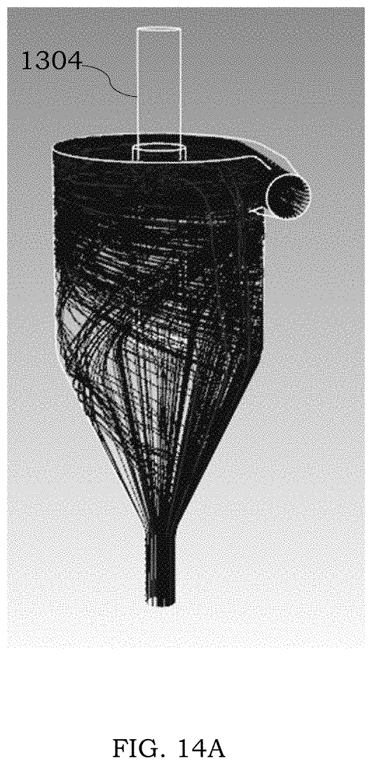

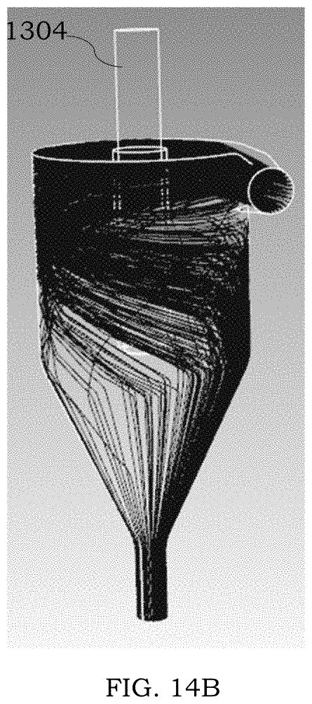

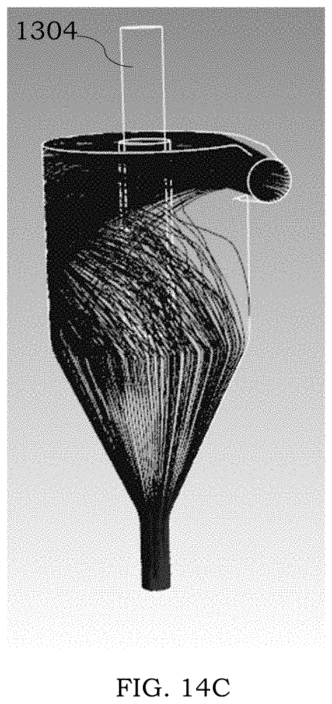

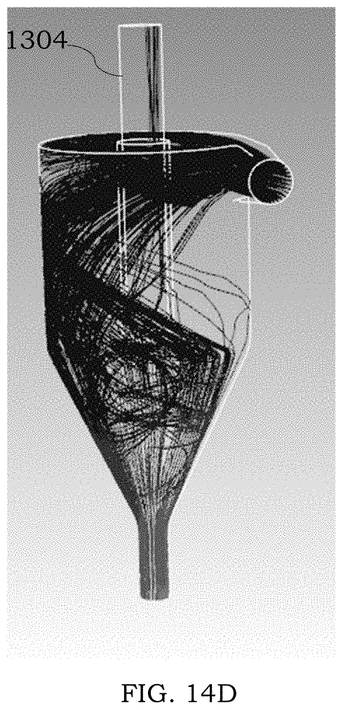

The results were consistent with the particle filter being able to remove all particles down to 30 microns average particle diameter. For example, FIG. 14A shows the results of the simulation for particles with an average diameter of 50 microns. No particles end up in the outlet 1304. FIG. 14B shows the results of the simulation for particles with an average diameter of 40 microns. No particles end up in the outlet 1304. FIG. 14C shows the results of the simulation for particles with an average diameter of 30 microns. No particles end up in the outlet 1304. FIG. 14D shows the results of the simulation for particles with an average diameter of 25 microns. Some of the 25 micron particles are starting to be pulled into the outlet 1304. Adjustment of inlet, outlet and/or filter geometry, size or using multiple particle filters in series may be used to filter out particles below 25 microns in size if desired.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A particle filter configured to remove particles from a fluid feed provided to a vacuum pump that can lower pressure in a system to less than atmospheric pressure, the particle filter positioned between the system and an inlet of the vacuum pump to remove particles from the fluid in the system prior to the fluid entering into the vacuum pump inlet without using any filtration media.

2. The particle filter of claim 1, wherein the particle filter comprises a cyclonic particle separator.

3. The particle filter of claim 2, wherein the cyclonic particle separator comprises an inlet, an outlet and a chamber that fluidically couples the inlet to the outlet, wherein the inlet of the particle filter comprises a different cross-sectional shape than the outlet of the cyclonic particle separator.

4. The particle filter of claim 2, wherein the cyclonic particle separator comprises an inlet, an outlet and a chamber that fluidically couples the inlet to the outlet, wherein the inlet of the particle filter comprises a similar cross-sectional shape than the outlet of the cyclonic particle separator.

5. The particle filter of claim 1, wherein the particle filter comprises an electrostatic screen.

6. The particle filter of claim 1, wherein the particle filter comprises a venturi scrubber.

7. The particle filter of claim 1, wherein the particle filter is configured to be in-line between a mass analyzer and a roughing pump of a mass spectrometer.

8. The particle filter of claim 1, further comprising a second particle filter fluidically coupled to the particle filter and positioned in series with the particle filter.

9. The particle filter of claim 1, further comprising a receptacle fluidically coupled to the particle filter and configured to receiver particles filtered out of the fluid.

10. The particle filter of claim 1, further comprising a valve between the receptacle and the particle filter, wherein the valve permits emptying of the receptacle without breaking vacuum in the system.

11. A method comprising reducing pressure in a device fluidically coupled to a vacuum pump by pumping fluid from the device through a particle filter positioned between the device and the vacuum pump, wherein the particle filter is configured to remove particles in the pumped fluid prior to the fluid entering into the vacuum pump by cyclonically separating the particles in the fluid.

12. The method of claim 11, wherein the device is a mass analyzer.

13. The method of claim 11, wherein the device is a vacuum deposition chamber.

14. The method of claim 11, wherein the device is a lyophilizer.

15. The method of claim 11, wherein the step of cyclonically separating the particles in the fluid comprises using a cyclonic particle separator.

16-20. (canceled)

21. A vacuum system comprising a vacuum pump and a particle filter upstream of an inlet of the vacuum pump, the particle filter configured to remove particles in a fluid prior to entry of the fluid into the vacuum pump, wherein the particle filter is configured to remove particles without using any filtration media.

22. The vacuum system of claim 21, wherein the particle filter comprises a cyclonic particle separator.

23. The vacuum system of claim 22, wherein an inlet of the cyclonic particle separator comprises a substantially similar inner diameter as an inner diameter of an outlet of the cyclonic particle separator.

24. The vacuum system of claim 21, wherein the particle filter comprises an electrostatic screen.

25. The vacuum system of claim 21, wherein the particle filter comprises a venturi scrubber.

26-42. (canceled)
